(19) United States
(12) Patent Application Publication
(10) Pub. No.: US 2017/0261420 A1
(43) Pub. Date: Sep. 14, 2017

(54) Stationary Assembly for Chemical Injection, Atomization, and Sacrificial Probe Corrosion Monitoring

(71) Applicant: George Patterson Bellis, SR., Erath, LA (US)

(72) Inventor: George Patterson Bellis, SR., Erath, LA (US)

(21) Appl. No.: 15/067,263

(22) Filed: Mar. 11, 2016

(51) Int. Cl. G01N 17/04

(52) U.S. Cl. CPC G01N 17/04

(57) ABSTRACT

A Stationary Assembly, for Chemical Injection, Atomization, and Sacrificial Probe Corrosion Monitoring that is configured around a main body portion, utilizing interchangeable lower end devices to perform these functions. The top inlet port of the apparatus accepts a chemical injection line for use with the injection quill or atomizer lower body portions, or a plug element for use with lower body portions that accept rod, disk, or flat type corrosion probes. Ports for equalization of pressure on the corrosion probe holder lower body portions for use with the plug element will also allow the use of a valve to allow fluid sampling at the corrosion monitoring site. Insertion depth similarities for these processes in a given high pressure vessel or flowline configuration allow the main body portion to perform the functions associated with the individual lower body portions.

### BACKGROUND OF THE INVENTION

Field of the Invention

The apparatus of the present invention relates to devices for threadably sealable attachment of chemical injection quills and atomizers, and installing corrosion monitoring probes on to thread-o-lets on high pressure vessels and flowlines for that purpose. More particularly, the present invention relates to the utilization of a main body portion, that includes lower body portions to accommodate these processes.

General Background of the Invention

In the technology of the integrity of vessels and flowlines, there has developed a technique whereby a variety of sacrificial probes and chemical injection devices, are used to monitor and treat certain properties of the high-pressure fluids transported within said high-pressure vessels and flowlines. Sacrificial probes are pre-weighed samples of metal similar to the metal used in the fabrication of the high-pressure vessel or flowline. Sacrificial probes are exposed to the high-pressure fluids within the high-pressure vessel or flowline for a predefined period, and then removed for processing. The weight loss of the probe experienced during exposure to the high-pressure fluids is then converted to a mills-per-year corrosion rate estimate that can be applied to the high-pressure vessel or flowline. This method of monitoring corrosion has been in use for decades, and although new techniques for monitoring corrosion are available, the practice continues to be very common. In relation to either of the methods mentioned for monitoring the properties and condition of the high-pressure fluids, there is the need for application of chemical compounds to offset the effects of the high-pressure fluids on the high-pressure vessel or flowline. Examples of probes used for this purpose include chemical injection quills that prevent immediate contact with the inner surface of the high-pressure vessel or flowline before the chemical can be absorbed into the high-pressure fluids, and chemical atomizers that reduce the particle size of the chemical for improved contact with and absorption into the high-pressure fluids.

In the current state of the art, stationary chemical injection quills and atomizers, and corrosion probe holders, use an individual apparatus to perform these processes. In the current state of the art, an engineer planning a chemical injection and corrosion monitoring program for a given production facility would use a vast array of devices for these processes.

### BRIEF SUMMARY OF THE INVENTION

The apparatus and method of the present invention solves the problem in a simple and straightforward manner. What is provided is a main body with threading for attachment to a thread-o-let on a high pressure vessel or flowline, an extension tube suitable for the insertion depth into the high pressure vessel or flowline, and attachments to allow the main body to perform any of these chemical injection or corrosion monitoring processes.

Therefore, it is the principle object of the present invention to provide an improved apparatus for use with a wide range of sacrificial probe corrosion monitoring and chemical injection processes.

It is a further object of the present invention to provide an improved apparatus that can be configured at the installation site to perform any of said chemical injection or corrosion monitoring processes.

It is a further object of the present invention to provide an apparatus wherein the insertion depth relative to a given installation is common to these processes.

It is a further object of the present invention to provide an injection quill attachment that allows horizontal installation via drip grooves that force corrosive treatments to drip off of the assembly tip and into fluids providing dilution.

It is a further object of the present invention to provide a main body upper port that can be fitted with a valve element to collect fluid samples when in use as a corrosion probe holder for direct comparison to corrosion probe results.

It is a further object of the present invention to provide a chemical atomization element designed specifically for the apparatus, that supplies an improved, reduced particle size of the atomized chemical for contact with and absorption into the high-pressure fluids.

### BRIEF DESCRIPTION OF THE SEVERAL VIEWS OF THE DRAWING

For a further understanding of the nature, objects, and advantages of the present invention, references can be had to the following detailed description, read in conjunction with the following drawings, wherein like reference numerals denote like elements and wherein:

FIG. 1A comprises a side elevation in cross section and illustrates the main body of the apparatus.

FIG. 1B comprises a side elevation in cross section and illustrates the injection quill lower body portion of the apparatus.

FIG. 1C comprises a side elevation in cross section of the atomizer lower body portion of the apparatus, including a top view of the spring retainer with additional fluid passage ports.

FIG. 1D comprises a side elevation in cross section of the corrosion probe holder lower body portion of the apparatus for use with rod and disk type corrosion probes. This said lower body portion is constructed of a non-conductive material with vertical grooves to equalize pressure, which will be discussed further, and includes a top and bottom elevation for clarification of said grooves.

FIG. 1E comprises a side elevation in cross section of the corrosion probe holder lower body portion of the apparatus for use with flat corrosion probes, and includes side elevations of non-conductive elements, and the retaining screw used to secure the flat corrosion probes to the apparatus.

FIG. 1F comprises a side elevation in cross section of a plug element used when the device is used as a corrosion probe holder.

FIG. 2A comprises a side elevation of the main body portion.

FIG. 2B comprises a side elevation and illustrates the injection quill lower body portion of the apparatus.

FIG. 2C comprises a side elevation of the atomizer lower body portion of the apparatus.

FIG. 2D comprises a side elevation of the corrosion probe holder lower body portion of the apparatus, for use with rod and disk type corrosion probes.

FIG. 2E comprises a side elevation of the corrosion probe holder lower body portion of the apparatus for use with flat corrosion probes, with the likeness of a flat corrosion probe installed on the apparatus.

FIG. 2F comprises a side elevation of a plug element used when the device is used as a corrosion probe holder.

FIG. 2G comprises a side elevation of the likeness of a rod type corrosion probe.

FIG. 2H comprises a side elevation of the likeness of a disk type corrosion probe and the screw element used to attach it to the corrosion probe holder illustrated in FIG. 2D, including bottom elevations of the disk type corrosion probe and the screw element.

FIG. 2I comprises a front elevation of the likeness of a flat type corrosion probe.

FIG. 3A comprises a side elevation of the apparatus with injection quill lower body portion installed, and the apparatus installed in a cross section of flowline, to depict the purpose of the drip grooves on said injection quill lower body portion.

FIG. 3B comprises a side elevation in cross section of the main body portion with the injection quill lower body portion installed, with the apparatus installed in a section of high pressure vessel or flowline with the likeness of a chemical injection attachment and chemical passage associated with a vertically installed injection quill.

FIG. 3C comprises a side elevation in cross section of the main body portion with the atomizer lower body portion installed, with the apparatus installed in a section of high pressure vessel or flowline with the likeness of a chemical injection attachment and chemical passage associated with an atomizer.

FIG. 3D comprises a side elevation in cross section of the main body portion with the corrosion probe holder lower body portion for rod type corrosion probes installed, with the likeness of a rod type corrosion probe installed, and installed in a section of high pressure vessel or flowline, with the threadably, sealable attached sampling valve element used with this assembly installed.

FIG. 4A comprises a side elevation of the main body portion with the injection quill lower body portion installed, with the likeness of a chemical injection line attached, and fluids consistent with an injection quill coming out of lower end.

FIG. 4B comprises a side elevation of the main body portion with the atomizer lower body portion installed, with the likeness of a chemical injection line attached, and fluids consistent with an atomizer coming out of lower end.

FIG. 4C comprises a side elevation of the main body portion with the corrosion probe holder lower body portion for use with flat type corrosion probes installed, with the likeness of a flat corrosion probe installed, and the threadably, sealable attached sampling valve element option installed.

FIG. 4D comprises a side elevation of the main body portion with the corrosion probe holder lower body portion for use with rod or disk type corrosion probes installed, with the likeness of a rod corrosion probe installed, and with the threadably, sealable attached plug element option installed.

FIG. 4E comprises a side elevation of the main body portion with the corrosion probe holder lower body portion for use with rod or disk type corrosion probes installed, with the likeness of a disk corrosion probe installed, and with the threadably sealable attached plug element option installed.

### DETAILED DESCRIPTION OF THE INVENTION

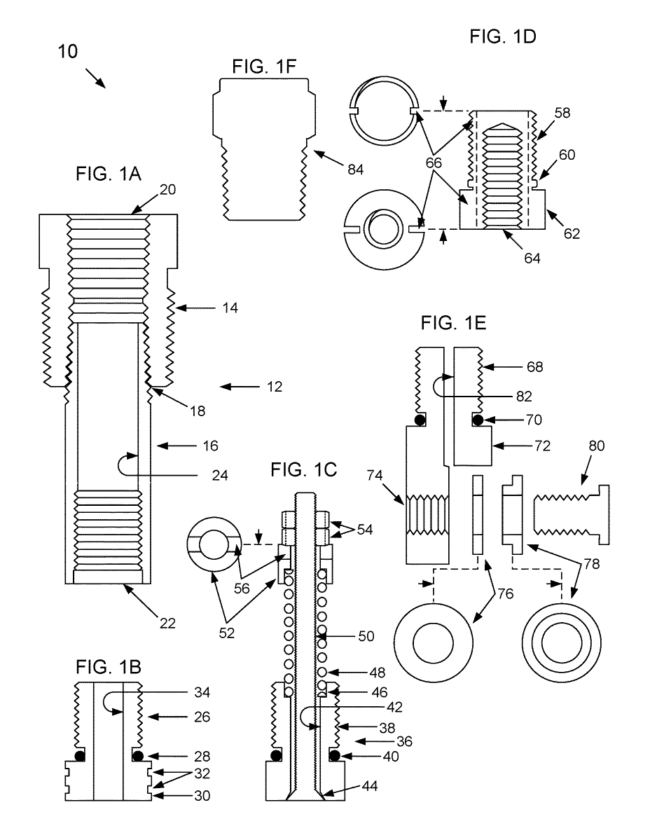

FIGS. 1-4 illustrate the apparatus of the present invention referenced by the numeral 10. As illustrated initially, FIG. 1A comprises a side elevation in cross section of the main body portion 12 and an externally threaded upper portion 14 for threadably sealable connection to a thread-o-let access point on a high-pressure vessel or flowline, which will be discussed and illustrated further. Main body portion 12 further comprises internal threads 20 for connection to chemical supply lines for injection or a plugging element as illustrated in FIG. 1F, for use as a corrosion probe holder. Returning to FIG. 1A, further comprises lower generally elongated tubular portion 16 threadably and sealable attached 18, to upper portion 14, and forming a continuous inner bore defined by inner wall 24. Lower generally elongated tubular portion 16 further comprises an internal threaded lower portion 22 for threadably, sealable connection to lower body portions illustrated in FIG. 1B, FIG. 1C, FIG. 1D, and FIG. 1E, which will be discussed further.

FIG. 1B comprises a side elevation in cross section of the injection quill lower body portion, comprising a threaded upper body portion 26, an O-ring 28 for threadably sealable connection to internally threaded lower portion 22 of FIG. 1A. Returning to FIG. 1B, injection quill lower body portion further comprises a lower body portion 30, having drip grooves 32 which force corrosive liquids to drip off of said lower body portion 30 when installed in a horizontal configuration, which will be discussed further. Injection quill lower body portion further comprises a continuous inner bore defined by inner wall 34.

FIG. 1C comprises a side elevation in cross section of the atomizer lower body portion comprising a lower body portion 36, having an upper threaded portion 38 and an O-ring 40 for threadably sealable connection to internally threaded lower portion 22 of FIG. 1A. Returning to FIG. 1C, lower body portion 36 further comprises a continuous inner bore defined by inner wall 42 terminating at the bottom with an angled seat 44, and terminating at the top with a spring seat 46 for retaining spring element 48. FIG. 1C atomizer lower body portion further comprises a piston element 50 passing through lower body portion 36, spring element 48, upper spring retaining element 52 and retained in place by nut elements 54. Upper spring retaining element 52 further comprises a fluid passage 56, to allow fluid passage in addition to passage through the spring element 48. Further detail of upper spring retainer element 52 and fluid passage 56 can be had with a top elevation of upper spring retainer element 52 in FIG. 1C. FIG. 1D comprises a side elevation in cross section of the rod and disk type non-conductive corrosion probe holder lower body portion comprising an upper threaded portion 58, a raised shoulder 60 to match the dimensions of O-ring elements in FIG. 1B, FIG. 1C, and FIG. 1E. Returning to FIG. 1D, rod and disk type non-conductive corrosion probe holder lower body portion further comprises lower body portion 62, wherein a threaded bore begins upward through said lower body portion 62 and ends before the upper wall of upper threaded portion 58, defining a non-conductive threaded receptacle 64 for rod and disk type corrosion probes. A continuous notch 66 begins upward from the bottom wall of lower body portion 62 and continues upward through upper threaded portion 58, for equalization of pressure which will be discussed further. Further detail of continuous notch 66 can be had with a top elevation and bottom elevation of FIG. 1D rod and disk type non-conductive corrosion probe holder lower body portion.

FIG. 1E comprises a side elevation in cross section of the flat type corrosion probe holder lower body portion comprising an upper threaded portion 68, an O-ring element 70 for threadably sealable connection to internally threaded lower portion 22 of FIG. 1A. Returning to FIG. 1E, flat type corrosion probe holder lower body portion further comprises lower body portion 72, having a continuous threaded bore 74, non-conductive elements 76 and 78, and a retaining screw element 80. Further detail of non-conductive elements 76 and 78 can be had with side elevations included in FIG. 1E flat type corrosion probe holder lower body portion, and their purpose will be clarified further in the figures. Flat type corrosion probe holder lower body portion further comprises a continuous bore defined by inner wall 82 for pressure equalization, which will be discussed further.

FIG. 1F comprises a side elevation in cross section of a threadably sealable plug element 84 for use with corrosion probe holding lower body portions FIG. 1D and FIG. 1E.

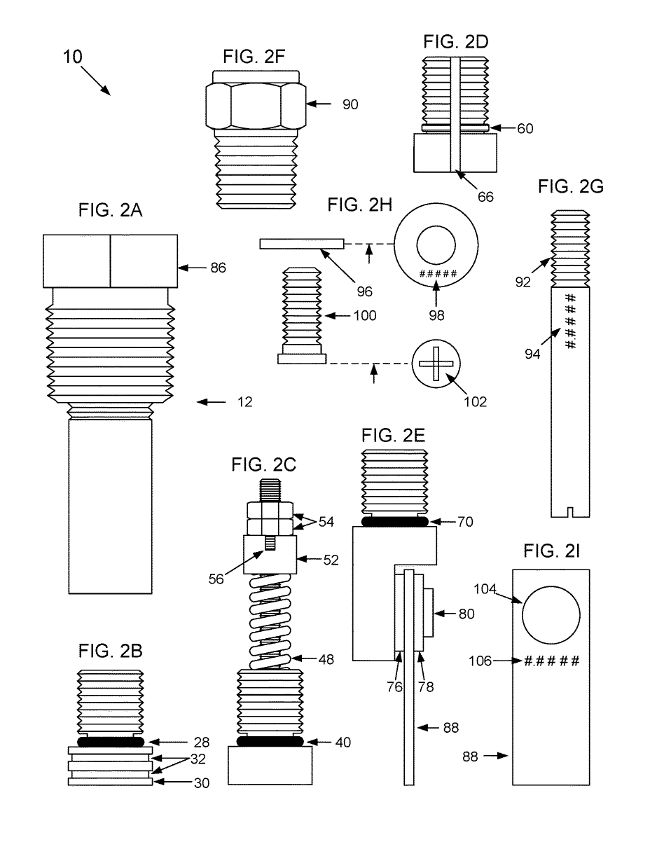

FIG. 2A comprises a side elevation of the main body portion 12 and provides detail to the upper body portion hexagon upper portion 86.

FIG. 2B comprises a side elevation of the injection quill lower body portion and provides further detail to the O-ring 28, lower body portion 30, and drip grooves 32.

FIG. 2C comprises a side elevation of the atomizer lower body portion and provides further detail to the O-ring 40, and spring element 48. FIG. 2C side elevation of the atomizer lower body portion further comprises a 90 degree rotated view of the upper spring retainer element 52, giving further detail to fluid passage 56. FIG. 2C further comprises greater detail to nut elements 54.

FIG. 2D comprises a side elevation of the rod and disk type non-conductive corrosion probe holder lower body portion and provides further detail to raised shoulder 60 to match the dimensions of O-ring elements in FIG. 2B, FIG. 2C, and FIG. 2E. Returning to FIG. 2D rod and disk type non-conductive corrosion probe holder lower body portion provides further detail to continuous notch 66.

FIG. 2E comprises a side elevation of the flat type corrosion probe holder lower body portion providing further detail to O-ring element 70 and is illustrated with non-conductive elements 76 and 78, and retaining screw element 80 installed into continuous threaded bore 74 of FIG. 1E which is not visible in this side elevation. Returning to FIG. 2E, said side elevation of the flat type corrosion probe holder lower body portion further comprises a likeness of a flat type corrosion probe 88 installed on the flat type corrosion probe holder lower body portion.

FIG. 2F comprises a side elevation of the threadably sealable plug element 84 providing further detail to hexagon upper body portion 90.

FIG. 2G comprises a side elevation of the likeness of a rod type corrosion probe and providing detail to the upper threaded portion 92 and the customary weight stamp to one thousandth of a gram 94.

FIG. 2H comprises a side elevation of a disk type corrosion probe 96, and includes a bottom elevation of a disk type corrosion probe and the customary weight stamp to one thousandth of a gram 98. FIG. 2H further comprises a side elevation of the mounting and retaining element 100, and includes a bottom elevation having detail to the drive mechanism 102.

FIG. 2I comprises a front elevation of a flat type corrosion probe 88, providing detail to the mounting hole 104, and the customary weight stamp to one thousandth of a gram 106.

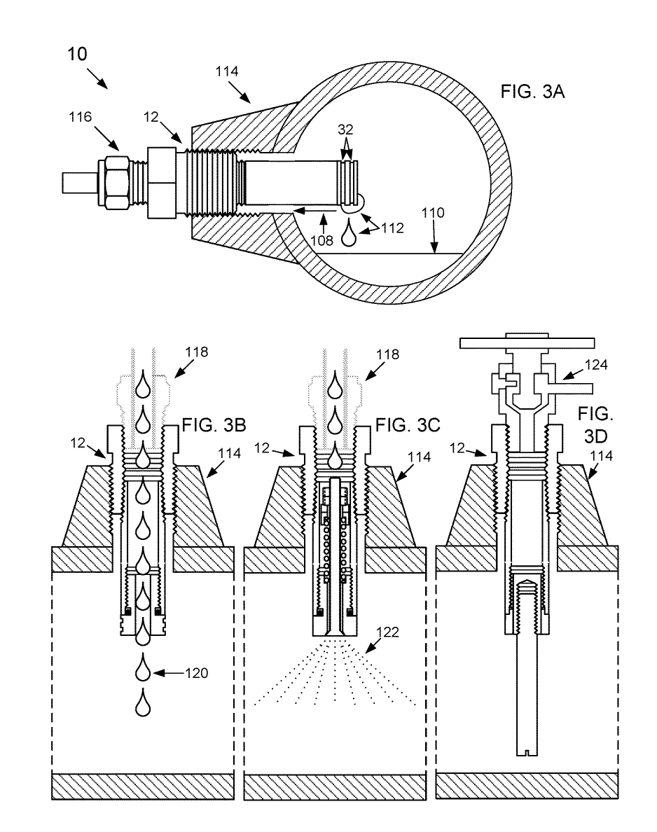

FIG. 3A comprises a side elevation of the main body portion 12 with the injection quill element detailed in FIG. 1B and FIG. 2B installed onto the main body portion 12. Returning to FIG. 3A further provides a depiction of the apparatus mounted in horizontal orientation within a high pressure vessel or flowline thread-o-let in cross section 114, providing detail to the function of the drip grooves 32. FIG. 3A further comprises a side elevation of the likeness of a chemical injection line 116 attached to the apparatus. Drip grooves 32 force corrosive liquids to drip off over and into fluids 110 as depicted 112 within the high pressure vessel or flowline stopping said corrosive treatments from following the path depicted by arrow 108 and contacting the vessel or flowline.

FIG. 3B comprises a side elevation in cross section of main body portion 12 with the injection quill lower body portion detailed in FIG. 1B and FIG. 2B installed onto the main body portion 12, returning to FIG. 3B, and mounted in a vertical orientation within a section of high pressure vessel or flowline thread-o-let in cross section 114. FIG. 3B further comprises the likeness of a chemical injection connection 118, and depicts the fluid behavior 120, of a quill injection scenario.

FIG. 3C comprises a side elevation in cross section of main body portion 12 with the with the atomizer lower body portion detailed in FIG. 1C and FIG. 2C installed onto the main body portion 12, returning to FIG. 3C, and mounted in a vertical orientation within a section of high pressure vessel or flowline thread-o-let in cross section 114. FIG. 3C further comprises the likeness of a chemical injection connection 118, and depicts the fluid behavior 122, of an atomizer injection scenario.

FIG. 3D comprises a side elevation in cross section of the main body portion 12 with the rod and disk type non-conductive corrosion probe holder lower body portion detailed in FIG. 1D and FIG. 2D installed onto the main body portion 12, returning to FIG. 3D, and mounted in a vertical orientation within a section of high pressure vessel or flowline thread-o-let in cross section 114. FIG. 3D further comprises the likeness of a rod type corrosion probe as depicted in FIG. 2G installed on the rod and disk type non-conductive corrosion probe holder lower body portion detailed in FIG. 1D and FIG. 2D. Returning to FIG. 3D further comprises a sample valve element 124 option installed on the apparatus.

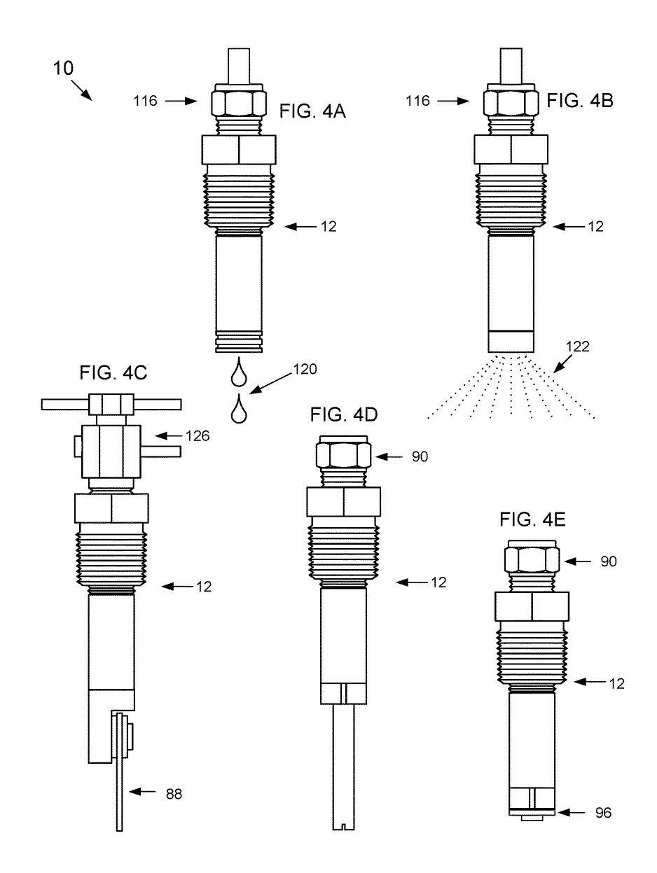

FIG. 4A comprises a side elevation of the main body portion 12 with the injection quill lower body portion installed, with the likeness of a chemical injection line 116 attached, and fluid behavior 120, consistent with an injection quill.

FIG. 4B comprises a side elevation of the main body portion 12 with the atomizer lower body portion installed, with the likeness of a chemical injection line 116 attached, and fluid behavior 122, consistent with an atomizer.

FIG. 4C comprises a side elevation of the main body portion 12 with the corrosion probe holder lower body portion for use with flat type corrosion probes installed, with the likeness of a flat type corrosion probe 88 installed, and a side elevation of the likeness of a threadably sealable sampling valve element 126 installed.

FIG. 4D comprises a side elevation of the main body portion 12 with the corrosion probe holder lower body portion for use with rod or disk type corrosion probes installed, with the likeness of a rod type corrosion probe installed, and a threadably sealable plug element 84 installed.

FIG. 4E comprises a side elevation of the main body portion 12 with the corrosion probe holder lower body portion for use with rod or disk type corrosion probes installed, with the likeness of a disk type corrosion probe 96 installed, and a threadably sealable plug element 84 installed.

1. A Stationary Assembly, for Chemical Injection, Atomization, and Sacrificial Probe Corrosion Monitoring comprising:
a. A main body portion providing the ability to accommodate various insertion depths into high pressure vessels or flowlines.
b. A main body portion providing threadably, sealable attachment to a high pressure vessel or flowline thread-o-let port.
c. A main body portion providing threadably, sealable attachment to a chemical supply inlet.
d. A main body portion providing threadably, sealable attachment to an injection quill lower body portion.
e. A main body portion providing threadably, sealable attachment to an injection quill lower body portion having drip grooves.
f. A main body portion providing threadably, sealable attachment to an atomizer lower body portion.

2. Apparatus in claim 1, wherein the lower body portion of the main body portion threadably, sealable attachment to the upper portion of the main body portion allows the main body portion to be made to lengths to accommodate different insertion depths of high pressure vessels and flowlines.

3. Apparatus in claim 1, wherein the high pressure vessel or flowline thread-o-let provides stationary mounting of the apparatus with any of said lower body portions.

4. Apparatus in claim 1, wherein the upper port of the apparatus provides connection to a chemical supply line of a higher pressure than the internal pressure of the high pressure vessel or flowline for use with chemical injection lower body portions.

5. Apparatus in claim 1, wherein the injection quill lower body portion provides protection to the inner walls of the high pressure vessel or flowline by directing corrosive treatment chemicals into fluids within the high pressure vessel or flowline for dilution.

6. Apparatus in claim 1, wherein a horizontal installation of the injection quill lower body portion prevents runback of corrosive chemicals to the inner wall of the high pressure vessel or flowline with drip grooves that force said corrosive chemicals to drip off of the injection quill lower body portion and into fluids within the high pressure vessel or flowline for dilution.

7. Apparatus in claim 1, wherein a chemical atomizing device designed specifically for the apparatus offers improved chemical throughput, atomization, and utilization of chemicals.

8. A Stationary Assembly, for Chemical Injection, Atomization, and Sacrificial Probe Corrosion Monitoring comprising:
a. A rod or disk type corrosion probe holder portion comprising continuous grooves down opposite sides of the body for equalization of pressure.
b. A rod or disk type corrosion probe holder comprising a shoulder element to lock the rod or disk type corrosion probe holder into the main body portion.
c. A flat type corrosion probe holder portion comprising a continuous center bore for the equalization of pressure.
d. An atomizer lower body portion comprising an upper spring retainer for stabilizing the spring and improving centering of piston element.
e. Ported corrosion probe holder lower body portions allowing the apparatus to be configured as a sample point.

9. Apparatus in claim 8, wherein the rod or disk type corrosion probe holder comprises grooves down two sides to equalize pressure between the main body portion and the high pressure vessel or flowline when used with the plug element.

10. Apparatus in claim 8, wherein the rod or disk type corrosion probe holder comprises a shoulder made onto the rod or disk type corrosion probe holder that mimics the O-ring element of the other lower body portions to lock the rod or disk type corrosion probe holder in place on the main body portion.

11. Apparatus in claim 8, wherein the flat type corrosion probe holder comprises a continuous center bore to equalize pressure between the main body portion and the high pressure vessel or flowline when used with the plug element.

12. Apparatus in claim 8, wherein the atomizer lower body portion comprises an upper spring retainer element that holds the piston in the center of the spring and improves the positioning of the lower end of said piston element in the atomizer lower body portion thereby improving atomization.

13. Apparatus in claim 8, wherein the pressure equalization ports in corrosion probe holders allow the plug element to be replaced with a valve element and provide a sample point for high pressure fluids at the corrosion probe monitoring point.

14. A Stationary Assembly, for Chemical Injection, Atomization, and Sacrificial Probe Corrosion Monitoring comprising:
a. An atomizer lower body portion providing improved fluid passage via a fluid port in the spring retainer for that purpose.
b. An atomizer lower body portion comprising an extended piston length and double nut attachment.
c. A main body portion providing threadably, sealable attachment to a rod or disk type corrosion monitoring probe holder.
d. A rod or disc type corrosion probe holder lower body portion made from high pressure and temperature capable non-conductive material.
e. A main body portion providing threadably, sealable attachment to a flat type corrosion monitoring probe holder.
f. A flat type corrosion probe holder lower body portion utilizing flat type corrosion probe mounting elements made from high pressure and temperature capable non-conductive material.

15. Apparatus in claim 14, wherein the atomizer lower body portion comprises a fluid port to allow chemical passage within the space between the piston element and internal diameter of the spring element that would otherwise travel between the wire wraps of the spring element.

16. Apparatus in claim 14, wherein the atomizer lower body portion comprises an extended piston element secured with double nut elements that allow adjustment of the compression of the spring element to optimize atomization for different viscosity chemical treatments.

17. Apparatus in claim 14, wherein the rod or disk type corrosion probe lower body portion provide ease of changing between corrosion probe types to achieve different types of data collection.

18. Apparatus in claim 14, wherein the rod or disk type corrosion probe holder is constructed of non-conductive material capable of high pressure and temperature tolerance associated with high pressure vessels and flowlines.

19. Apparatus in claim 14, wherein the flat type corrosion probe lower body portion allow ease of changing between corrosion probe types to achieve different types of data collection.

20. Apparatus in claim 14, wherein the flat type corrosion probe holder comprises mounting elements for the flat type corrosion probes that are constructed of non-conductive material capable of high pressure and temperature tolerance associated with high pressure vessels and flowlines.
